(19) United States
(12) Patent Application Publication
(10) Pub. No.: US 2012/0072436 A1
(43) Pub. Date: Mar. 22, 2012

(54) Relationship and Content Management Application

(75) Inventors: Lester S. Pierre, Valley Cottage, NY (US); Fu E. Luo, Brooklyn, NY (US); Michael J. Russo, Staten Island, NY (US)

(73) Assignee: Wall Street Network, Inc.

(21) Appl. No.: 12/885,976

(22) Filed: Sep. 20, 2010

(51) Int. Cl. G06F 17/30

(52) U.S. Cl. 707/758; 707/705; 707/E17.009; 707/E17.014

(57) ABSTRACT

A web-based Relationship and Content Management Application combining an organization's CRM and ECM systems by integrating CRM's contacts with an ECM system's key features and functionality. The user of such is able to efficiently store and retrieve a combination of information for a relationship from CRM as well as from ECM, avoiding human error and providing data centralization. Users may store and retrieve content from both internal document repositories within an ECM system as well as external document repositories in the user's system. The major features consist of the ease of use and data consistency, plus the leverages of CRM as the centralization of data.

### BACKGROUND OF THE INVENTION

1. Field of the Invention

Organizations use a variety of systems to maintain and organize business relationships as well as business content, including but not limited to, business documents and files. An organization typically uses one system for business relationships and another for business content. A search first must be done on the relationship system to retrieve needed contact information, followed by a separate input and search of the retrieved contact information in a separate business content storage system. Typically, organizations utilize Customer Relationship Management (CRM) solutions as the system for managing business relationships and Enterprise Content Management (ECM) solutions as the system for storing business content.

CRM is a well known approach for managing and developing a company's relations with those outside of the company. It allows for the organization of all aspects of a business, which revolves around both customer management and internal management. For example, in various implementations, the CRM system may be MICROSOFT DYNAMICS CRM.

With an ECM system, organizations securely protect critical documents, files, and all other forms of business content. After content is collected and protected, users have access to allowed documents, files, and information. For example, in various implementations, the ECM system may be CLEARVIEW SOFTWARE.

The existing CRM and ECM systems in the industry both allow a user to store documents. However, an alternate user attempting to the retrieve the stored document has difficulty retrieving the document using CRM if the user does not know exactly where the document has been stored, making the process lengthy and difficult. This results in searching all stored repositories for the needed document. When using an ECM system, a user must input correct information in order to retrieve content; more times than not a user will input the incorrect information, whether misinformation or a simple misspelling, causing either the retrieval of incorrect content or the mistaken belief that content does not exist. The user will then create a separate contact and folder with the misinformation, defeating the purposes of both CRM and ECM. Furthermore, organizations using both CRM and ECM systems require the steps of manually retrieving required relationship information from CRM and manually entering this relationship information for business content retrieval from an ECM system. These are the business problems solved by the present invention. The present invention contains both CRM and ECM functionality allowing all users of such to locate and view with ease any stored content. In fact, both CRM and ECM require “looking” for content; the present invention is able to “look” for the content allowing one to view content immediately.

While both CRM and ECM are widely used to manage organizations, nowhere in the art exists a solution where both CRM and ECM come together to provide one solution where user required relationship information is imported from CRM and fed into an ECM system in order to perform business content retrieval from ECM without user input. The present invention is a web-based application that helps integrate CRM's contacts with an ECM system's key features and functionality. The present invention aids in efficiently storing and retrieving a combination of information for a relationship from CRM as well as from an ECM system, thereby avoiding human error and providing data centralization as interactions or inputs by humans are minimized.

The present invention further allows for a preview of documents that are stored or retrieved from an ECM system resulting in efficiency and reducing search time for content related to that CRM entity. Once content is retrieved, its images are displayed in an easy to view format allowing one to flip through the various retrieved content. Additionally, users may also store and retrieve documents from both internal document repositories in an ECM system as well as external document repositories in the user's system, such as MICROSOFT SHAREPOINT document repositories. The major features of the present invention consist of the ease of use and data consistency, plus the leverages of CRM as the centralization of data.

2. Description of the Prior Art

There are other applications designed for organization of business needs. Typical of these is U.S. Pat. No. 7,502,997, issued to Reid on Mar. 10, 2009.

A patent application was published for Coon on Feb. 14, 2008 as U.S. Patent Application Publication No. 20080040196. Yet another U.S. Patent Application Publication No. 20090106271 was published for Chieu on Apr. 23, 2009.

### U.S. Pat. No. 7,502,997

### Inventor: Gregory S. Reid, et al

### Issued: Mar. 10, 2009

New functions for a contact center system include: testing user's comprehension of informational messages with a quiz; capturing insight of superior users having a KPI score above a threshold by having those users submit information on why they perform so well; dynamically ordering solutions to issues by re-ranking the solutions periodically based on recency and frequency; integrating information for use by a contact center representative while online with a customer and information for use when not online; storing content items in a telecommunications industry taxonomy; directing user feedback on a content item to the proper owner/manager of that content; communicating solution information using a solutions taxonomy; displaying a dual information system having a CRM application as well as reference material that is context-appropriate; enforcing completion of a group of templates when creating a content item to be published; ensuring a group of templates for a content item are complete before publishing them; and searching within a contact center system portal using a continuum of search functions.

### U.S. Patent Application Publication Number U.S.20080040196

### Inventor: Robert E. Coon, et al

### Published: Feb. 14, 2008

A method, system and program product for hosting an on-demand customer interaction contact center utility infrastructure is provided. The method includes negotiating competitive prices with a plurality of vendors for each of the plurality of components of the on-demand customer interaction center utility infrastructure. Further, the method includes providing an on-demand customer interaction center utility infrastructure serving a plurality of customers and including a plurality of components. The method includes configuring a solution for a customer, the solution including sharing one or more components of the plurality of components of the on-demand customer interaction center utility infrastructure and establishing metrics to be monitored and achieved for the customer for calculating a customer utilization fee, such that the customer pays for the one or more components utilized in the on-demand customer interaction center utility infrastructure based on achievement of the metrics established and monitored.

### U.S. Patent Application Publication Number U.S. 20090106271

### Inventor: Trieu C. Chieu, et al

### Published: Apr. 23, 2009

An enterprise content management system such as an electronic contract system manages a large number of secure documents for many organizations. The search of these private documents for different organizational users with role-based access control is a challenging task. A content-based extensible mark-up language (XML)-annotated secure-index search mechanism is provided that provides an effective search and retrieval of private documents with document-level security. The search mechanism includes a document analysis framework for text analysis and annotation, a search indexer to build and incorporate document access control information directly into a search index, an XML-based search engine, and a compound query generation technique to join user role and organization information into search query. By incorporating document access information directly into the search index and combining user information in the search query, search and retrieval of private contract document can be achieved very effectively and securely with high performance.

### SUMMARY OF THE PRESENT INVENTION

The present invention relates generally to relationships and content organization and, more specifically to a web-based relationship and content management application which combines CRM capabilities with an ECM system's functionality to provide for a solution whereby the user of such may easily retrieve content from an ECM system by leveraging relationship information in the CRM.

A primary object of the present invention is to provide a relationship and content organizational solution where an organization's existing ECM system uses an existing CRM system to manage customer relations. Organizations using a CRM system have various pieces of meta information, and the present invention allows for the import of ECM content from CRM, eliminating the need for manual human interaction in an ECM system that is required for content indexes.

Another object of the present invention is to provide a relationship and content organizational solution where documents previously stored in an existing ECM system may be retrieved based on relationships associated to that content.

Yet another object of the present invention is to provide a contact and content organizational solution where a user may configure metadata from CRM and set up relationship entities; such as, but not limited to, account entities, service activities, and work orders. Such relationship related metadata interacts with an ECM's content indexes to retrieve the required content.

Still yet other object of the present invention is to provide a contact and content organizational solution having the capability of configuring the mappings of CRM metadata with ECM's Indexes. ECM Indexes consist of metadata associated with content. With the help of these mappings, a contact's information may be automatically fed into the ECM system and the related content retrieved from ECM.

Another object of the present invention is to provide a relationship and content organizational solution having improved work flow and technology enhancements. This is possible by using a display of content images, such as thumbnail images, which are easy to view images of the content. Such a technology enhancement eliminates manually searching through any retrieved ECM content. This technology allows a user to flow through business content (such as documents or files) by selecting a contact within CRM instead of opening a new program and forcing the user to search each file for the desired content.

The present invention overcomes the shortcomings of the prior art by providing a means for organizing and retrieving both business relationships and business content within one solution allowing for the ease of use and consistency of data with the leverage of data centralization. Nowhere in the prior art exists an organizational solution which combines CRM and ECM functionality to provide one user friendly, easily accessible business solution. Furthermore, the combination of CRM and ECM along with searching features and image preview greatly reduces the time needed by a user to search through thousands, if not millions, of separate pieces of business content.

The foregoing and other objects and advantages will appear from the description to follow. In the description, reference is made to the accompanying drawings, which forms a part hereof, and in which is shown by way of illustration of specific embodiments in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a flow diagram illustrating one example of the integration of an organization's CRM system with that organization's ECM system;

FIG. 2 is a flow diagram illustrating one example of the steps the present invention utilizes when searching ECM content using CRM relationship information in the present invention;

FIG. 3 is a flow diagram illustrating one example of the search functionality of the present invention;

FIG. 4 is a screen shot illustrating one example of the user Quick Search feature of the present invention;

FIG. 5 is a flow diagram illustrating one example of how search results are rendered in the present invention;

FIG. 6 is a screen shot illustrating one example of information that may be presented to a user using Quick Search in the present invention;

FIG. 7 is a flow diagram illustrating one example of how content may be added in the present invention;

FIG. 8 is a screen shot illustrating one example of how new content may be added to ECM through CRM. Shown is the Add A New Document feature with one example of an ECM Content Type tree;

FIG. 9 is a screen shot illustrating the Import Form of the present invention;

FIG. 10 is a flow diagram illustrating one example of how an administrative user may configure mappings;

FIG. 11 is a flow diagram illustrating one example of how an administrative user may configure search mappings;

FIG. 12 is a flow diagram illustrating one example of how an administrative user may map CRM metadata to ECM's indexes;

FIG. 13 is a screen shot illustrating one example of an Administration page of the present invention;

FIG. 14 is a screen shot illustrating one example of the Administrator Settings page of the Administration page of the present invention;

FIG. 15 is a screen shot illustrating one example of how an administrative user may configure the present invention by adding new mappings;

FIG. 16 is a flow diagram illustrating one example of how an administrative user may connect an organization's CRM system to an ECM server; and

FIG. 17 is a screen shot illustrating one example of how an administrative user may configure the ECM server that is to be utilized by the present invention.

### DESCRIPTION OF THE REFERENCED NUMERALS

Turning now descriptively to the drawings, in which similar reference characters denote similar elements throughout the several views, the figures illustrate the Relationship and Content Management Application of the present invention. With regard to the referenced numerals used, the following numbering is used throughout the various drawing figures.
10 Relationship and Content Management Application of the present invention
12 CRM system
14 ECM system
16 quick search
18 content template
20 add a new document
22 image preview
24 content description table
26 browse
28 content type tree
30 import form
32 index
34 administration
36 administration settings
37 configure search mappings
38 add new mappings
40 configure server
42 entity name
44 CRM metadata
46 ECM index
48 import
50 configure ECM server
52 configure CRM server

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments; practitioners skilled in the art will recognize numerous other embodiments as well. For definition of the complete scope of the invention, the reader is directed to appended claims.

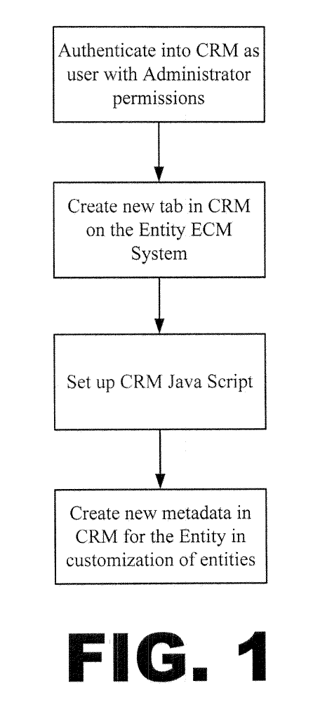

FIG. 1 is a flow diagram illustrating one example of the integration of an organization's CRM system with that organization's ECM system. The user of the CRM system must first authenticate into CRM as a user with Administrator permissions. The user creates a tab in the CRM system for the Entity ECM System. This may be done by creating a new section and intelligent frame having the Uniform Resource Locator (URL) for the ECM system used by the organization within the CRM system. The user then creates new CRM metadata for the Entity. This process allows an organization's ECM system to be viewed within their CRM system as one application without the need for opening multiple web pages.

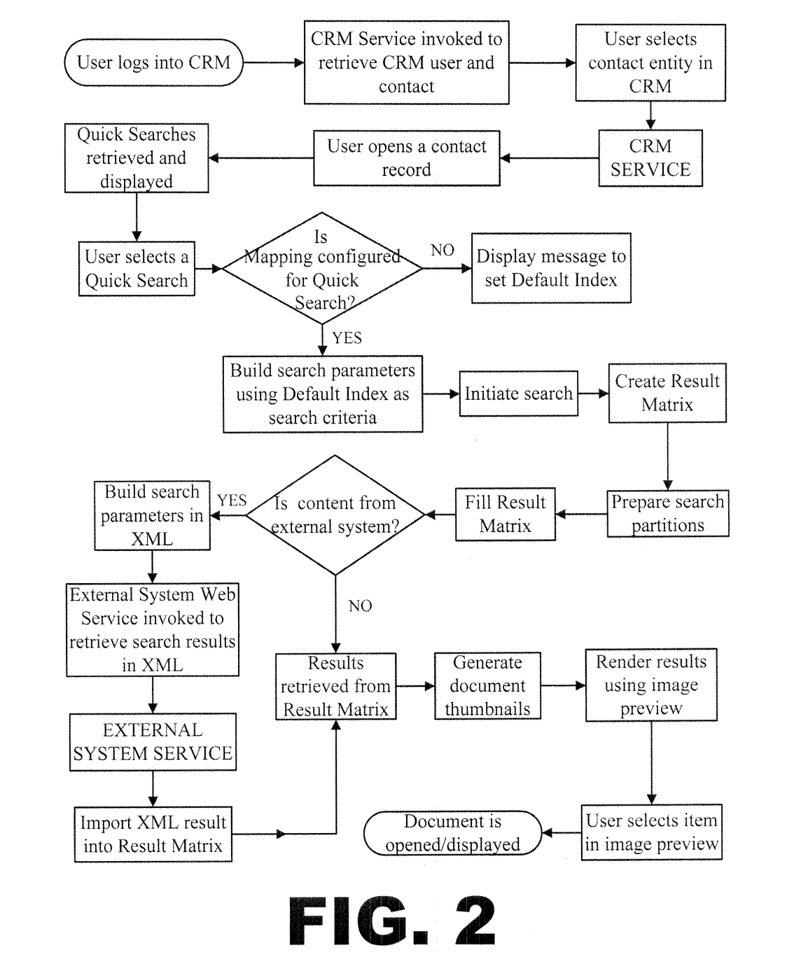

FIG. 2 is a flow diagram illustrating one example of the steps the present invention utilizes when searching ECM content using CRM relationship information in the present invention. The most frequently used document content templates utilized by an organization may be saved in a Quick Search feature of the present invention. The user saved Quick Search template names are available for user selection. A user selecting any one of the saved Quick Search names will display all documents, as an image, for the related content from ECM's document repository, or external repository, for that individual Entity. The user first enters the CRM system. The user selects a contact entity from CRM. The CRM Service is invoked to retrieve the CRM user and the user requested contact Entity. The user then opens a contact record. The user's previous Quick Searches are retrieved and displayed. From this Quick Search display, the user selects a particular Quick Search. If a mapping is configured for the Quick Search, search parameters are built using the default index as the search criteria. The search is initiated and a Result Matrix is created and filled. A Result Matrix is a temporary table where the searched results are saved and cached. The present invention retrieves data from this Result Matrix when needed. If content is not from an external system, the search results are retrieved from the Result Matrix and thumbnail images are generated for documents. The results are rendered using an image preview and the user may select items in the image preview which may be opened and displayed for user viewing. The image preview allows the user to view documents in many different file format types.

If, however, contents are from an external system, the search parameters may be built using Extensible Markup Language (XML). An External System Web Service is invoked to retrieve the search results in XML. The XML is imported into the Result Matrix. The search results are given from the Result Matrix and thumbnail images are generated for documents. The results are retrieved using the image preview and the user may select items in the image preview, which may be opened and displayed for user viewing.

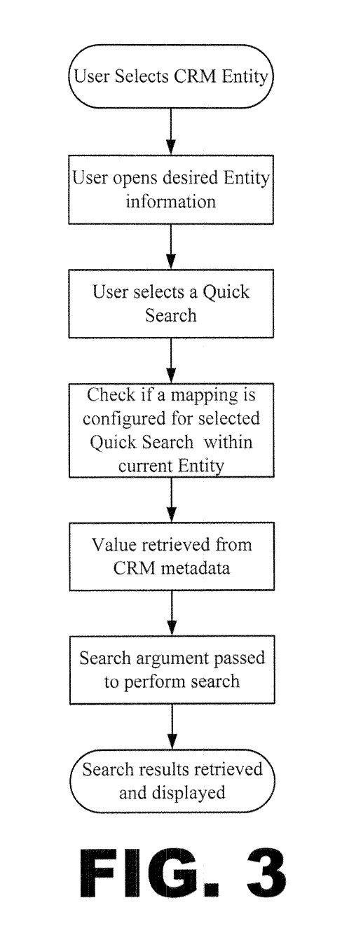

FIG. 3 is a flow diagram illustrating one example of the search functionality of the present invention. Once the user opens the desired information from an Entity, for example, a company record from the Account Entity, the Quick Searches for that CRM user are displayed. The user selects a Quick Search, for example, Signature Card, and the present invention checks if a mapping is configured for the selected Quick Search within the current Entity, which may be a mapping for the CRM Metadata of Account Name to an ECM Index of Company Name. The value, in this example, the selected company name, is retrieved from the CRM Metadata of Account Name, which was previously mapped to the ECM Index of Company Name using the Configure Search Mappings feature, discussed below. The search argument is passed to perform the search, and search results for the Entity are retrieved and displayed. Once the search mapping is configured for the Entity, the process works the same way for that Entity in each future use.

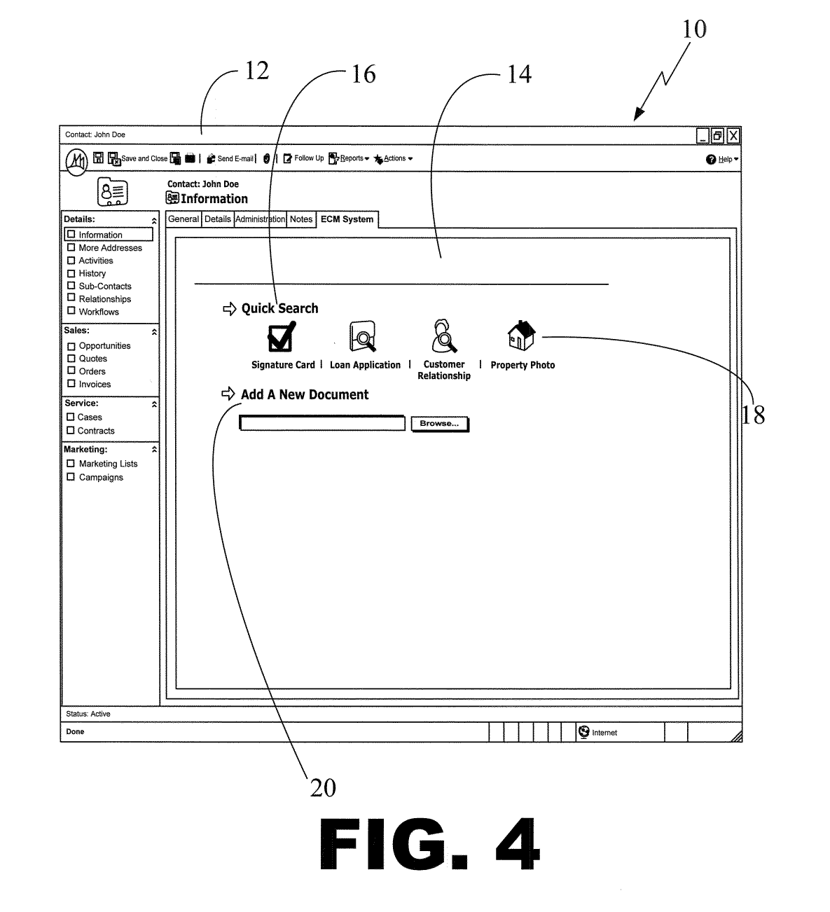

FIG. 4 is a screen shot illustrating one example of the user Quick Search 16 feature of the present invention 10. Shown is the ECM system 14 section within a CRM system 12. Also shown is the Quick Search 16 feature which contains the various frequently used document Content Templates 18 for a banking organization, and more specifically, loan applications. For purposes of explanation, a banking industries' relationships and content will be used in examples, however, any industry may configure their Quick Search 16 Content Templates 18 to display information pertinent to that particular industry and organization. Here, the banking organization has typically used the Content Templates 18 of signature card containing the contact's information, loan application, customer relationship, and property photos. Selecting any of these saved search names will display all documents as an image for the related content from ECM's document repository, or any external system repository, for that individual relationship, all through CRM.

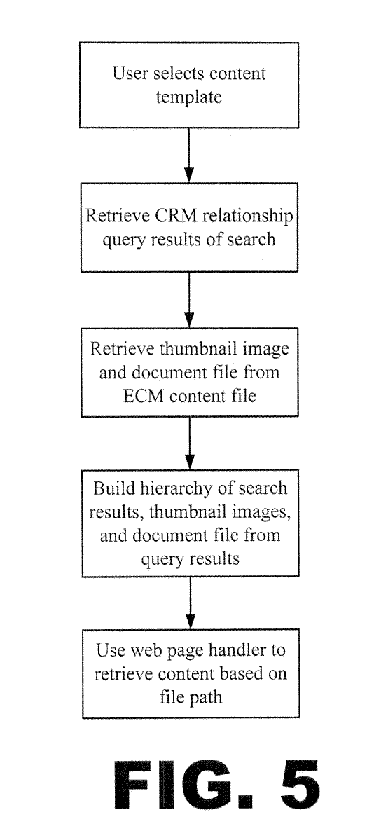

FIG. 5 is a flow diagram illustrating one example of how search results are rendered in the present invention. The user first performs a search by selecting a content template. The CRM relationship query results are retrieved for the search, which may include Content Name, Content Template ID and Index Values. The thumbnail images for the content file are retrieved from an ECM content file. A hierarchy is built containing the search results, thumbnail images and content file from the query results. Intelligent folder contents may be displayed as a root node. Any documents belonging to the intelligent folder are grouped as children nodes. A web page handler may be used to retrieve content based on its file path. The web page handler may be ashx or other framework. The file contains the hierarchy information, such as intelligent folder groupings and content information, such as index values, document location and thumbnail image.

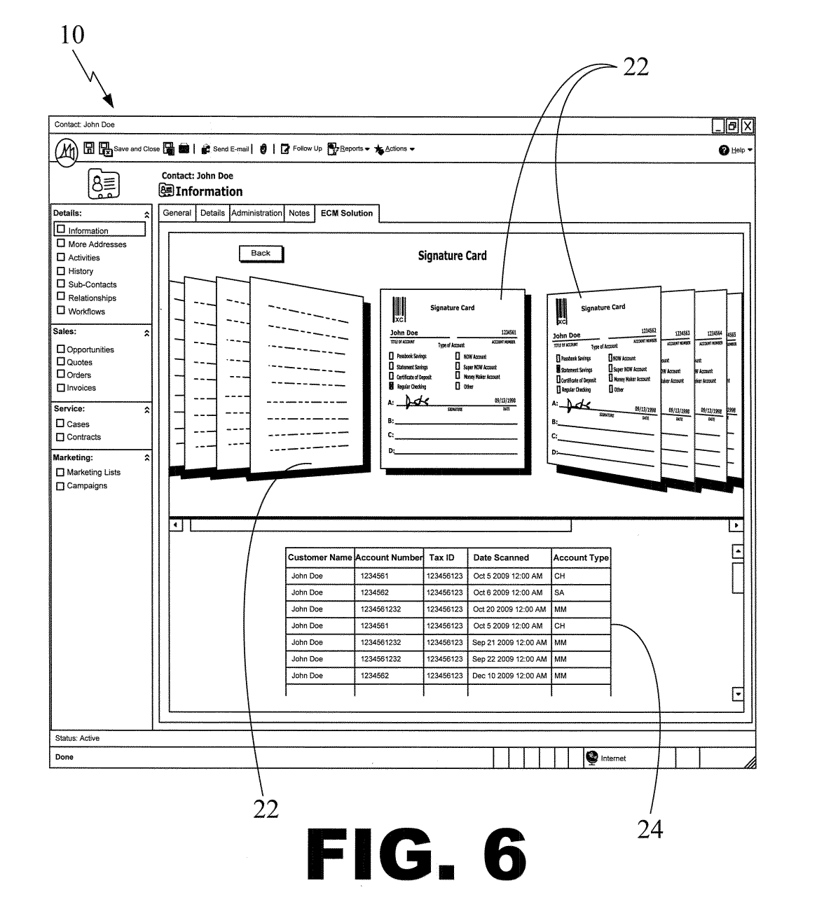

FIG. 6 is a screen shot illustrating one example of information that may be presented to a user using Quick Search in the present invention 10. The user search results are displayed as an Image Preview 22. The document Content Templates within Quick Search are displayed according to the user's saved settings. Selecting one of the folders, or saved Content Templates, will display all the documents that are saved for that document Content Template. Once a user selects one of the quick searches, the documents for that content template and relationships will be displayed using the Image Preview 22 allowing the user to view the content of the documents as an image preview. Shown are the documents Image Preview 22 once a user selects the Quick Search Signature Card, shown in FIG. 3. Shown is the content stored for Signature Card. The Image Preview 22 is positioned in such a way to allow the user to quickly browse through the documents. The user may select the images to open the documents. Also shown is a Content Description Table 24 containing basic information of the documents displayed in the image preview. A user may select and choose documents using this Content Description Table 24 as an alternative to flipping through the document images.

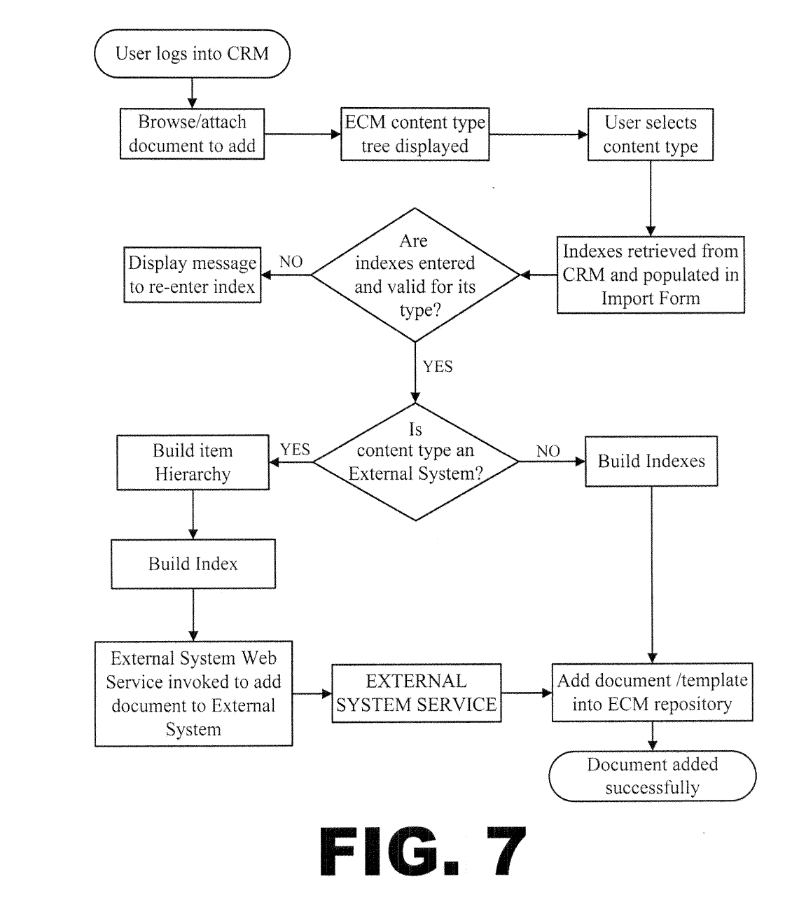

FIG. 7 is a flow diagram illustrating one example of how content may be added in the present invention. New content, or documents, may be added using the Add a New Document feature of the present invention. The user may select the appropriate content template and the document that is uploaded by the user will be stored in the template. The user first logs into CRM. The user then browses the system and attaches the content wished to be added. An ECM content type tree is displayed allowing the user to select a content type, which may be based on an organization's structure. For example, in a banking organization, one content type tree may contain the different types of loans. The content type tree provides a breakdown of the industry's pertinent activities. Once the user selects a content type, an Import form is displayed. Any indexes which are mapped and contain the wanted document information are retrieved from CRM and populated on the Import Form, which is a collection of textboxes. Examples of index types in a banking organization may include social security number, loan number, and number of credits taken. The system then performs data validation by determining whether the entered Indexes are valid for its type. For example, if bank account numbers are to be entered, the system will not allow non-numerical characters. If the Indexes entered are not valid for its type, a message will be displayed to the user to re-enter the index.

If the indexes entered are valid for its type, the present invention determines whether the content type is an external system. An ECM system having its own repository is considered to be an internal system. However, the present invention allows such an ECM system to integrate with other repositories, including, but not limited to, a SHAREPOINT External System Repository, which is considered an external system. If the content type is an external system, the indexes may be built in XML. Some index fields may be pre-populated, such as name and address, which are pulled from the CRM metadata for the particular Entity to allow for easier and accurate retrieval of the fields. The documents and templates are then added into the ECM repository. If, however, the content type is an external system, the item hierarchy and index may be built in XML. The External System Web Service is invoked to add content to the External System.

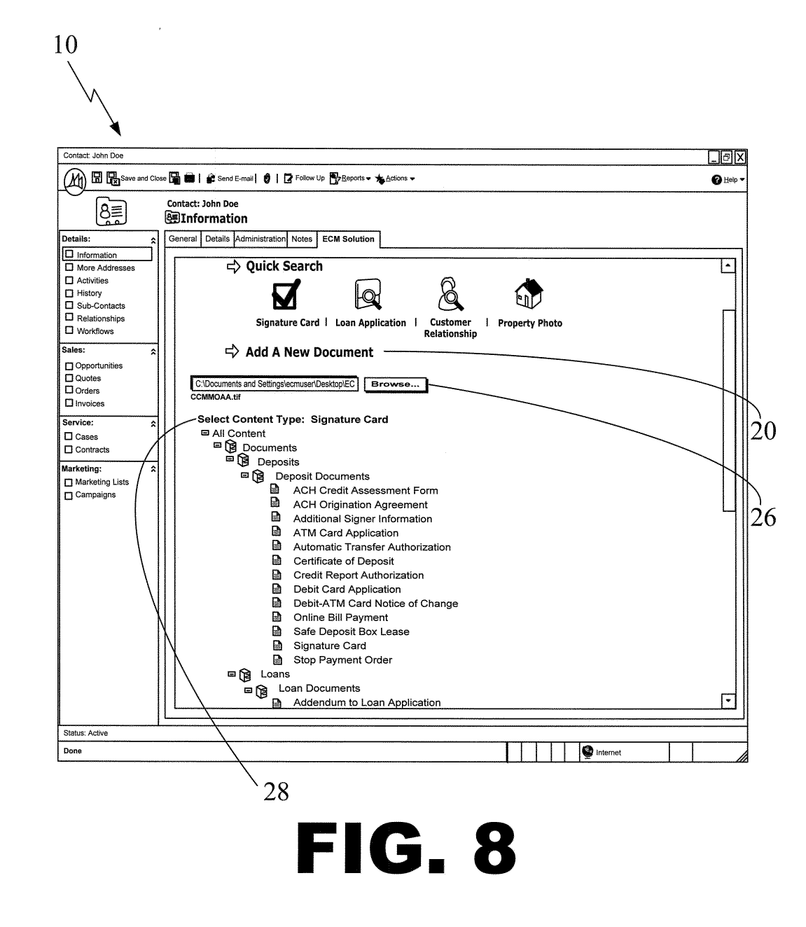

FIG. 8 is a screen shot illustrating one example of how new content may be added to ECM through CRM. Shown is the Add A New Document 20 feature with one example of an ECM Content Type 28 tree. Once the user selects Browse 26, the user may select the file to be uploaded from the user's system. Once the file has been attached, a modal dialog window appears and the user may select the content type from the ECM Content Type tree 28 to import the attached file into that content type. Upon selecting the content type, the modal dialog goes to a second window, the Import Form, which is displayed with the basic indexes required for later document retrieval. Shown is a user selection of the Signature Card within the Content Type tree 28.

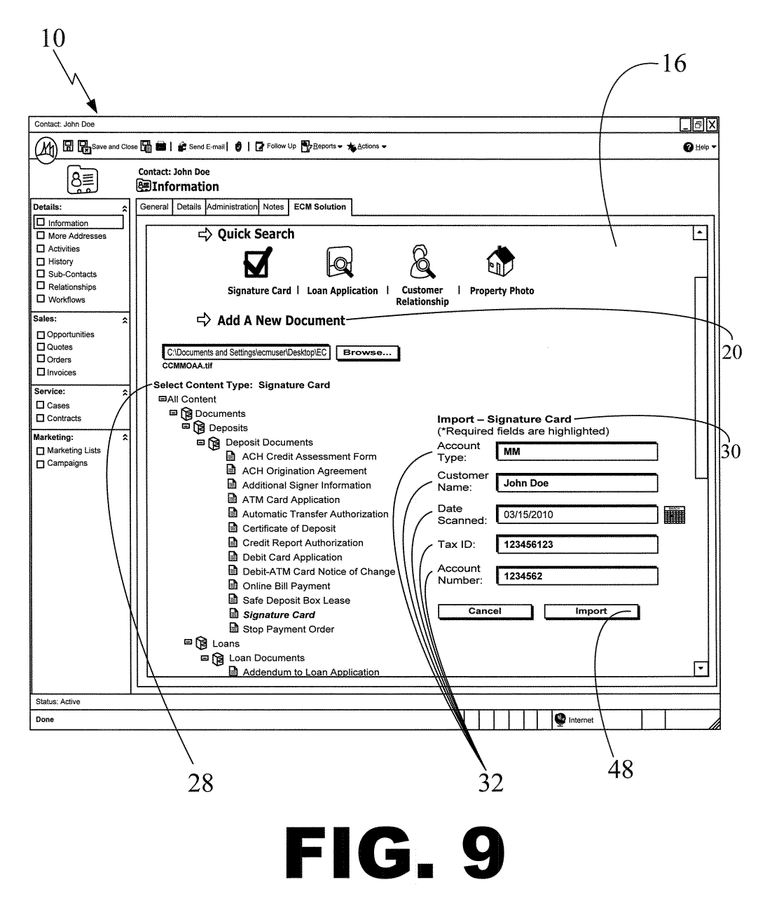

FIG. 9 is a screen shot illustrating the Import Form 30 of the present invention 10. Shown is one example of a Content Type tree 28 along with one possible Import Form 30 and Index 32. The information for the selected content type from FIG. 8 is retrieved from CRM and displayed in the appropriate Index 32 text boxes of the Import Form 30; in this example, the Signature Card. Shown are the Indexes 32 of Account Type, Customer Name, Date Scanned, Tax ID, and Account Number; these indexes are configurable by an administrative user and will vary based on the content type selected. The user may then enter the information that is missing, if any, and the document import process is complete. This process allows for uniform content organization which ensures that the content searched by an alternate user will be retrieved. Once Import 48 is completed, the uploaded file will be imported into the ECM document repository. The newly added document may be retrieved from ECM for future use using CRM's relationship information.

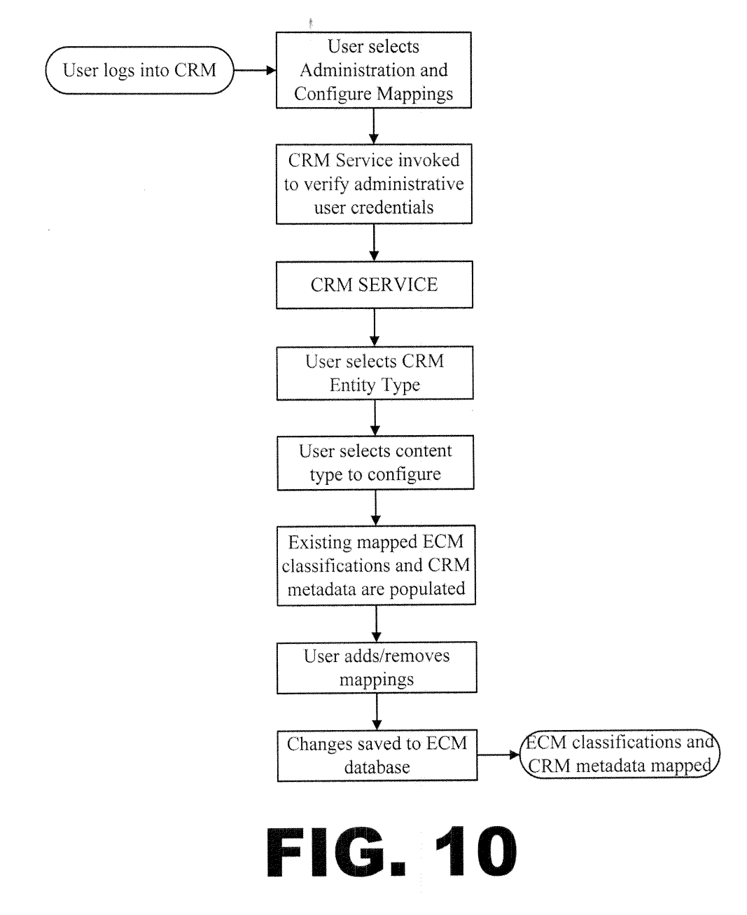

FIG. 10 is a flow diagram illustrating one example of how an administrative user may configure mappings. The present invention enables an administrative user to configure the mappings of CRM Metadata with ECM's Indexes. This is what allows for a selected Entity's information to be automatically populated in the appropriate textboxes during import, as described above. The user first logs into CRM, then selects the Administration Tab. Within the Administration tab, the user selects Configure Mappings, which invokes the CRM service. The CRM Service checks if the user is a member of the present invention's administrative team or if the user is a CRM system administrator. The user selects the CRM Entity Type and the content type to configure. CRM Entities represents objects such as Accounts, Contacts, Case and so on that have the capability to apply mappings on their metadata such as Account Name, Full Name and Case Number. This allows for CRM to be configured for a relationship entity, such as an account or other type of entity, which will work on custom or predefined entities in CRM. The existing mapped ECM indexes and CRM metadata are then populated. This creates a connection between CRM metadata and ECM metadata. The user may add or remove mappings and the changes are saved to the database. The ECM indexes and CRM metadata are then mapped.

By configuring mappings, an administrative user may have the ability to configure both search mappings and import mappings, as described above. Configuring search mappings allows users to search different indexes for each Entity. For example, the administrative user may set Company Name to be a default search Index configured on the Account Entity and set Customer Name to be the default Index configured on the Contact Entity. A Search Mapping Configuration Page allows the administrative user to configure the default index for each Entity. In order for a user to return results from a Quick Search, a default index in the present invention must be set for each Entity when multiple Entities are in existence. Account Entity default index may be Account Name or Company Name, and Contact Entity default index may be Customer Name or Full Name. Having the default index set as Customer Name will not retrieve or return results if a user decides to search on an Account Entity as opposed to a Contact Entity.

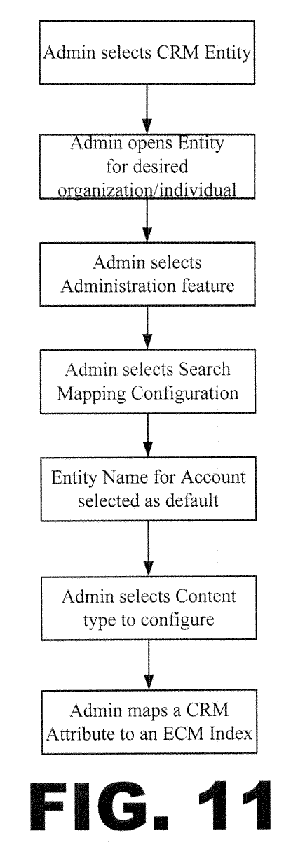

FIG. 11 is a flow diagram illustrating one example of how an administrative user may configure search mappings. The administrator first selects an Entity within CRM, for example, Account. The administrator opens the selected Entity for the desired information. The administrator then selects the Configure Search Mapping within the Administration page. The Entity Name, in this example, Account, will be selected as the default index from a drop down list. The default selection is based on the current Entity a user is in. The user then selects the Content Type to configure. The user finally maps a CRM Attribute to an ECM Index. For example, for an Account Entity, the CRM Attribute of Account Name to the ECM Index of Company Name, or for a Contact Entity, the CRM Attribute of Full Name to the ECM Index of Customer Name.

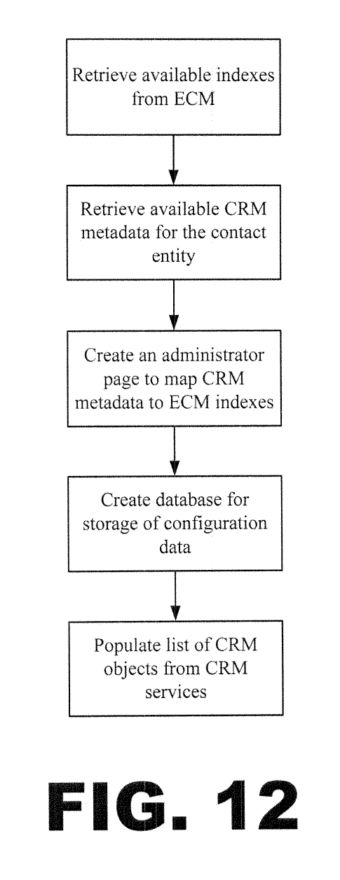

FIG. 12 is a flow diagram illustrating one example of how an administrative user may map CRM metadata to ECM's indexes. The user first retrieves all available indexes from ECM by performing a query of ECM's index template to retrieve the Index ID, Index Map ID and Index Name ID by executing a Structured Query Language (SQL) statement and passing in parameters of each selected Content Template. The user retrieves all available CRM metadata of the relationship entity using the CRM Metadata Service. The retrieved information may contain all the metadata in Extensible Markup Language (XML) format. The XML is parsed to retrieve the metadata, metadata display names, and metadata Globally Unique Identifier (GUID). The user may then create an administrator page to map CRM metadata to ECM indexes. These pages may include, but are not limited to, an Administrator Settings Page, a Configure Search Mappings Page, and a Add New Mappings Page. In order to configure mappings, the user may select a content template from the tree view. The user then configures mappings for that selected content template. The user may lock the mappings to allow that mapping to be updated and reflected in all the ECM Indexes with that Index Name. The user creates a database for the storage of configuration data. The data types may be GUID, varchar, or others. The user then populates a list of all initial CRM objects from CRM services based on the Metadata ID, as well as a list of initial ECM object from the ECM database, based on the Index ID.

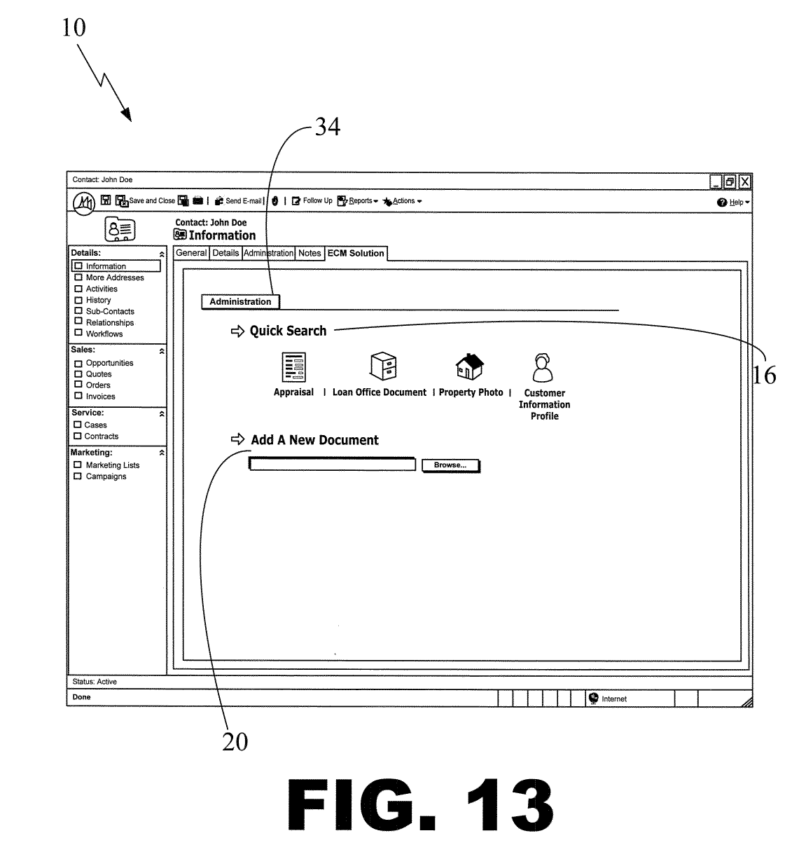

FIG. 13 is a screen shot illustrating one example of an Administration page 34 of the present invention 10. Shown are the Quick Searches 16 available to this particular administrative user as well as the Add A New Document 20 feature.

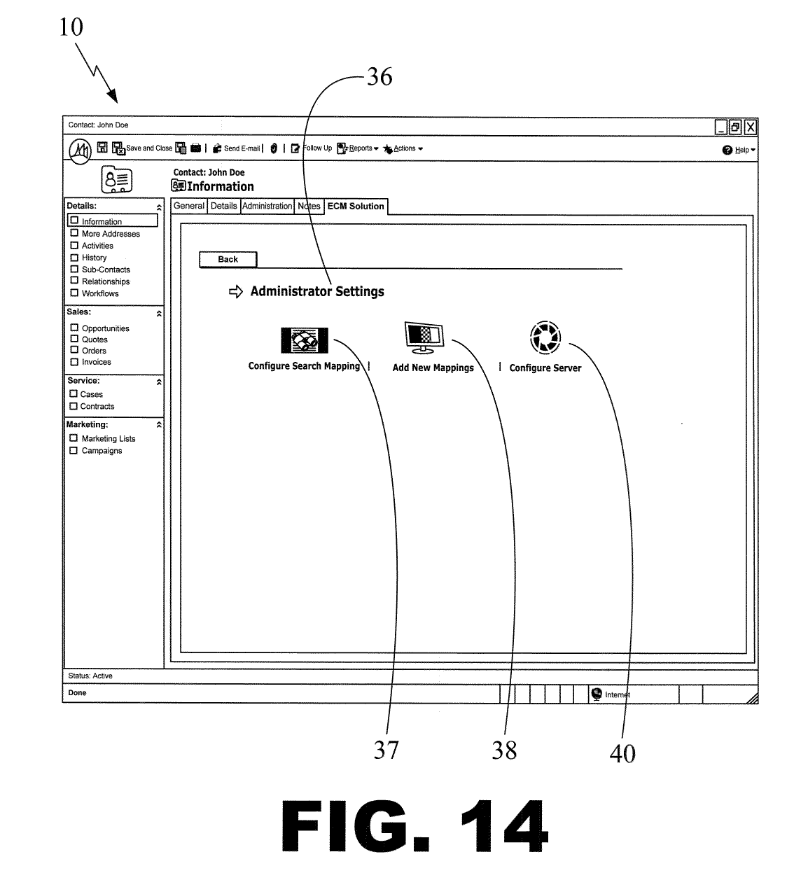

FIG. 14 is a screen shot illustrating one example of the Administrator Settings page 36 of the Administration page of the present invention. Shown are the administration settings for the Configure Search Mappings 37, Add New Mappings 38 and Configure ECM Server 40 features.

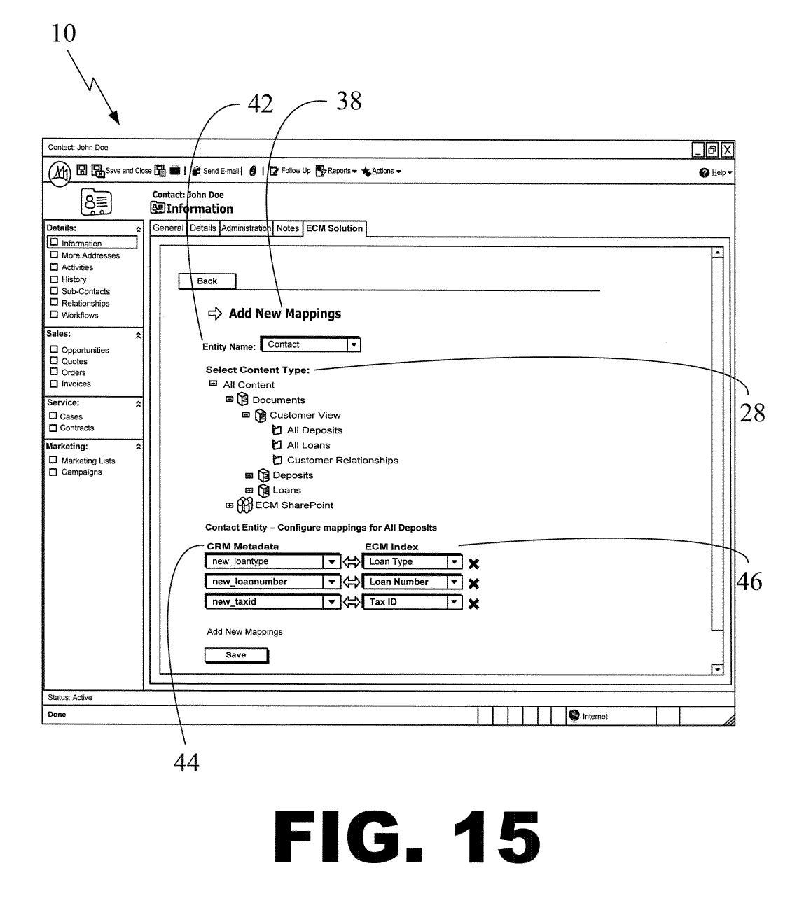

FIG. 15 is a screen shot illustrating one example of how an administrative user may configure the present invention by adding new mappings. An administrator may add the organization required mappings to any content type by selecting the CRM Metadata 44 that needs to be mapped with the ECM Index 46. The user first selects the Entity Name 42 and content type from the Content Type tree 28. By selecting Add New Mappings 38, a new row is added to configure the mapping for the selected content type and two menus appear for CRM Metadata 44 and ECM Index 46. Existing mappings may be removed and additional mappings may be added.

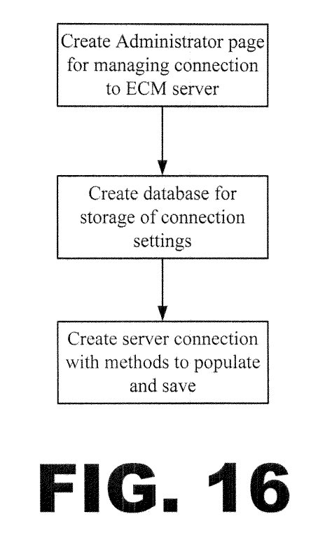

FIG. 16 is a flow diagram illustrating one example of how an administrative user may connect an organization's CRM system to an ECM server. The user first creates an administrator page for managing a connection to an ECM server. A database is created for the storage of various connection settings. The server connection is then created with the methods to populate and save. The present invention shall dynamically connect to the correct ECM web service server upon starting. This configuration page may manage connections for the ECM web service, ECM database, and the present invention's web service. The present invention uses the ECM Server Connection objects allowing the methods of populate and save for the storage of connection settings in the database. There are also security features to ensure only CRM administrators may see an Administrator Settings link on the main web page. Users without the CRM administrator credentials may only see the links for Quick Search and Import a New Document, as seen in FIG. 3. All CRM users of the present invention may use the same connection settings as configured by the administrative user.

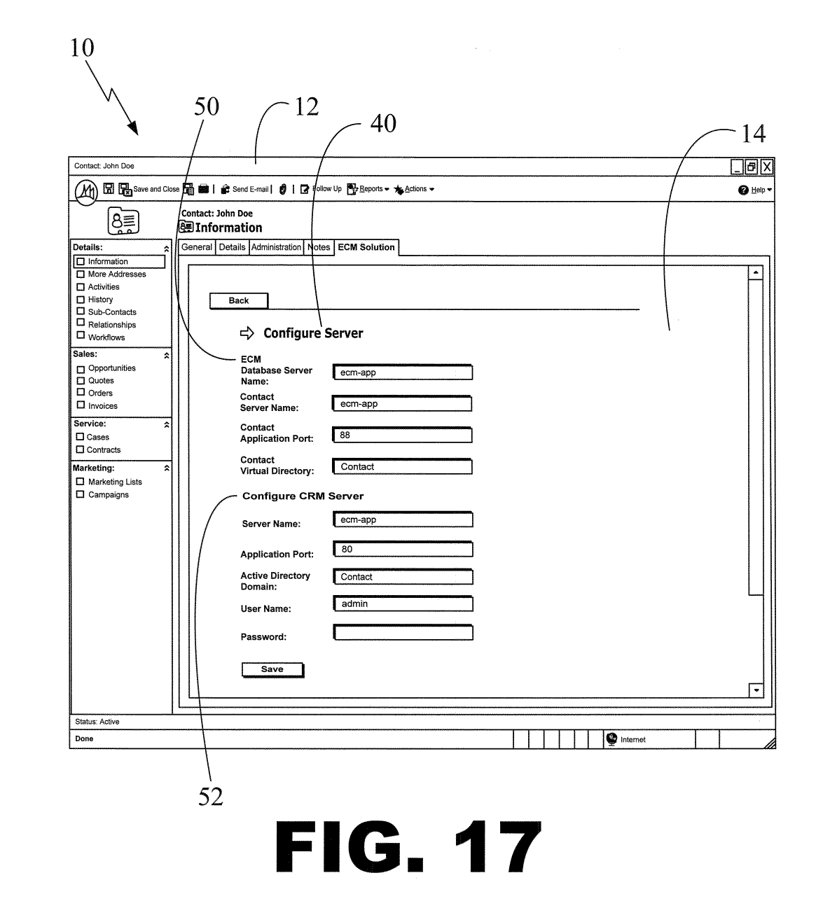

FIG. 17 is a screen shot illustrating one example of how an administrative user may configure the ECM server 50 that is to be utilized by the present invention 10. This allows the present invention 10 to be configured with both CRM 12 and ECM 14 systems utilized by an organization. This, in turn, allows for the passing of information between CRM and ECM through the present invention 10. Shown is the Configure Server 40 page of the Administration page. Both the ECM server 50 and CRM server 52 may be configured in order to provide a connection linking the two systems for information flow between the CRM system 12 and ECM system 14.

What is claimed is new and desired to be protected by Letters Patent and is set forth in the appended claims:

1. A relationship and content management application comprising:
a. a means for web access;
b. a Customer Relationship Management (CRM) system;
c. an Enterprise Content Management (ECM) system;
d. the combination of said Customer Relationship Management System with said Enterprise Content Management system; and
e. content retrieval from internal and external repositories.

2. The relationship and content management application according to claim 1, further comprising the method of importing information of a CUSTOMER RELATIONSHIP MANAGEMENT contact from saved user configurable CUSTOMER RELATIONSHIP MANAGEMENT metadata by way of CUSTOMER RELATIONSHIP MANAGEMENT contact entities interacting with ENTERPRISE CONTENT MANAGEMENT content indexes to retrieve ENTERPRISE CONTENT MANAGEMENT content and content from said internal and external content repositories.

3. The relationship and content management application according to claim 2, wherein said method comprises creating an ENTERPRISE CONTENT MANAGEMENT intelligent frame in said CUSTOMER RELATIONSHIP MANAGEMENT system on an entity ENTERPRISE CONTENT MANAGEMENT system and creating CUSTOMER RELATIONSHIP MANAGEMENT metadata for said entity ENTERPRISE CONTENT MANAGEMENT system.

4. The relationship and content management application according to claim 3, further comprising a means for searching ENTERPRISE CONTENT MANAGEMENT content through CUSTOMER RELATIONSHIP MANAGEMENT contact information; a means for adding content to said ENTERPRISE CONTENT MANAGEMENT system through CUSTOMER RELATIONSHIP MANAGEMENT contact information; a means for configuring mappings of said CUSTOMER RELATIONSHIP MANAGEMENT metadata with ENTERPRISE CONTENT MANAGEMENT Indexes; and a means for configuring server for connecting of said CUSTOMER RELATIONSHIP MANAGEMENT system to said ENTERPRISE CONTENT MANAGEMENT system.

5. The relationship and content management application according to claim 4, wherein said means for searching content comprises selecting a saved template for related content retrieval from ENTERPRISE CONTENT MANAGEMENT system repositories and external system content repositories; invoking a CUSTOMER RELATIONSHIP MANAGEMENT Service for retrieval of CUSTOMER RELATIONSHIP MANAGEMENT user and user requested contact entity; retrieving CUSTOMER RELATIONSHIP MANAGEMENT contact query results from said ENTERPRISE CONTENT MANAGEMENT system; saving of search results; retrieving data from search results; rendering results using image preview; and opening said image preview for viewing.

6. The relationship and content management application according to claim 5, wherein said search results are rendered using image previews for user selection of content.

7. The relationship and content, management application according to claim 4, wherein said means for adding content comprises browsing and attaching content; selecting a content type for document attachment from a content type tree; retrieving from said CUSTOMER RELATIONSHIP MANAGEMENT system content indexes content information; populating said content information; and adding of content and content templates into said internal repository.

8. The relationship and content management application according to claim 4, wherein said means for configuring mappings comprises a method of configuring CUSTOMER RELATIONSHIP MANAGEMENT for a relationship entity; querying ENTERPRISE CONTENT MANAGEMENT index templates for retrieval of ENTERPRISE CONTENT MANAGEMENT indexes; retrieval of CUSTOMER RELATIONSHIP MANAGEMENT metadata for relationship entities; creating a web page to map CUSTOMER RELATIONSHIP MANAGEMENT metadata to ENTERPRISE CONTENT MANAGEMENT indexes; selecting a content type from said content tree; creating a database for storage of configuration data; populating a list of CUSTOMER RELATIONSHIP MANAGEMENT objects from said CUSTOMER RELATIONSHIP MANAGEMENT Service with a list of ENTERPRISE CONTENT MANAGEMENT objects; and retrieving mappings by said CUSTOMER RELATIONSHIP MANAGEMENT system from said database to populate fields.

9. The relationship and content management application according to claim 4, wherein said means for configuring server comprises the method of creating a database for storage of connection settings; creating security features; creating ENTERPRISE CONTENT MANAGEMENT server connection object allowing methods of populate and save using connection setting for retrieval of ENTERPRISE CONTENT MANAGEMENT web services; removing any hard-coded ENTERPRISE CONTENT MANAGEMENT web services URL from page settings; and updating to use new connection implementation.
